(19) United States
(12) Patent Application Publication
(10) Pub. No.: US 2015/0360381 A1
(43) Pub. Date: Dec. 17, 2015

(54) Cutting Apparatus

(71) Applicants: Roydan T. Tomlinson, College Place, WA (US); Sean G. Calvert, Walla Walla, WA (US); Philip L. Hoffman, Walla Walla, WA (US)

(72) Inventors: Roydan T. Tomlinson, College Place, WA (US); Sean G. Calvert, Walla Walla, WA (US); Philip L. Hoffman, Walla Walla, WA (US)

(73) Assignee: KEY TECHNOLOGY, INC., Walla Walla, WA (US)

(21) Appl. No.: 14/306,539

(22) Filed: Jun. 17, 2014

(51) Int. Cl. B26D 5/00; B26D 5/08; B26D 5/30; B26D 5/06

(52) U.S. Cl. CPC B26D 5/007; B26D 5/06; B26D 5/086; B26D 5/30

(57) ABSTRACT

A cutting apparatus for use on a stream of discrete objects is described and which includes a conveying surface for transporting a stream of discrete objects; an image capturing device for capturing images of the discrete objects; a controller coupled to the image capturing device and which identifies foreign objects and unacceptable features of objects being processed; a voice coil actuator mounted above the conveying surface; and a knife mounted on the voice coil actuator and which is reciprocally moved into and out of engagement with objects passing therebeneath.

### TECHNICAL FIELD

The present invention relates to a cutting apparatus which is employed in connection with equipment for detecting defects or undesirable features in objects being processed, and further which is operable for cutting or severing the defects or undesirable features from the objects or products as they are being processed in a high-output production facility.

### BACKGROUND OF THE INVENTION

It has long been the objective of the food processing industry to devise high speed, mass flow, food inspection and processing systems for bulk food products such as potatoes, green beans, and similar vegetables so as to ensure a given quality, and the removal of substantially all defective or undesirable features of the products from a stream of products being processed. Heretofore, defect removal and quality control in the food processing industry had been labor intensive, and dependent upon the viability of the work force. As should be understood, the frequency and multitude of defects in raw bulk products is typically highly variable, and often depends, in large measure, upon local factors affecting the crops which are being processed. In years past, food processors have had to process large quantities of bulk raw products through different stages. To be cost effective, the food processing industry has sought to replace manually intensive methods with automated systems to achieve higher yields, better product quality, and reduced costs. Consequently, automated inspection cutting systems have been employed for a number of decades.

Prior art inspection and cutting systems have been constructed for optically inspecting elongated articles such as French fries and the like, and for separating the food articles based on whether the optical information indicates that the food article contains a defect or undesirable feature. Exemplary inspection and cutting apparatus and methods for same are illustrated and disclosed in U.S. Pat. No. 4,520,702, and U.S. Pat. No. 6,923,098, to name but a few. While the devices as seen in the aforementioned US patents (and which are incorporated by reference herein) have worked with a great degree success, and have been widely embraced by the food processing industry, food processors have strived for new processing devices which work with increasingly greater degrees of reliability.

The Office's attention is directed to pending U.S. patent application Ser. No. 13/066,790 and which was filed in the US Patent and Trademark Office on Apr. 25, 2011. This application has been published as US 2012/0266730 A1. The teachings of this reference are incorporated by reference herein. In this pending US application, further improvements have been made in a cutting assembly which has some features similar to the aforementioned U.S. Pat. Nos. 4,520,702 and 6,923,098. Notwithstanding the improvements made in the devices as described in these earlier references, food processors have continued to look for a cutting apparatus which may respond quickly, and reliably, and further may be used with a wide range of different products in a manner not possible heretofore.

A cutting apparatus which achieves these benefits, and avoids the detriments associated with the prior art devices and practices which have been previously utilized heretofore, is the subject matter of the present application.

### SUMMARY OF THE INVENTION

A first aspect of the present invention relates to a cutting apparatus which includes a conveying surface for transporting a stream of discrete objects along a predetermined course of travel; an image capturing device located in spaced relation relative to the conveying surface, and which generates an image signal which represents the individual discreet objects as they are transported by the conveying surface; a controller coupled in image signal receiving relation relative to the image capturing device, and wherein the controller is operable to identify objects within the stream of discrete objects, and which have unacceptable features, and which further must be removed from the stream of discrete objects, and wherein the controller generates a control signal which identifies a location of an object on the conveying surface which has an unacceptable feature; a voice coil actuator coupled in control signal receiving relation relative to the controller, and which is located in spaced relation relative to the conveying surface, and wherein the voice coil actuator is selectively electrically energized by the controller, and wherein the voice coil actuator further includes a drive member which moves reciprocally relative to the voice coil actuator, and in a direction both towards, and away from the conveying surface; and a knife mounted on the drive member of the voice coil actuator, and wherein the control signal transmitted by the controller is effective in selectively electrically energizing the voice coil actuator so as to reciprocally move the knife into and out of engagement with the object having unacceptable features at a location where the unacceptable feature begins, and ends, so as to effectively sever the unacceptable feature from the object.

Another aspect of the present invention relates to a cutting apparatus, which includes an elongated conveying surface having a longitudinal axis, and which transports a stream of discrete objects, and wherein the conveying surface has a first, intake end, and a second, exhaust end, and further conveys the stream of discrete objects at a given speed between the first and second ends thereof; a first image capturing device located elevationally, above, the elongated conveying surface, and which further generates an image signal which is representative of the discrete objects which are being transported past the image capturing device by the movement of the conveying surface; a first illumination device located elevationally, above, the conveying surface, and which, when energized, emits electromagnetic radiation which is reflected from the discrete objects which are passing below the first image capturing device, and which further is captured by the first image capturing device; a defect and foreign object removal device which is positioned adjacent to the second, exhaust end of the conveying surface; a first controller which is coupled in controlling, and image signal receiving relation relative to, the first image capturing device, and further is coupled in controlling relation relative to the elongated conveying surface, and first illumination device, and wherein the first controller is further operable to identify individual objects moving along in the stream of discrete objects, and which are either foreign objects, or discrete objects having an undesirable feature which must be removed from the stream of objects so as to produce a uniform stream of objects, and wherein the first controller generates a control signal which identifies a location on an identified object having an undesirable feature, and where the undesirable feature begins, and ends, or identifies the object as a foreign object, and wherein the control signal causes the first controller to generate a predetermined electrical current or a control signal; a first sensor for measuring an amperage of the electrical current which is generated by the first controller, and wherein the first sensor is coupled in signal transmitting relation relative to the first controller; a second sensor for measuring the voltage of the electrical current which is generated by the first controller, and wherein the second sensor is coupled in signal transmitting relation relative to the first controller; an admittance measuring device which is electrically coupled with each of the first controller, and the second sensor, in a feed-back loop, and which is further coupled in signal transmitting relation relative to the first controller; a voice coil actuator which is electrically, and controllably coupled with the first controller, and which is further positioned elevationally, above, the conveying surface, and wherein the voice coil actuator receives the electrical current which is generated by the first controller, and wherein the voice coil actuator further includes a moveable drive member having a distal end, and wherein the voice coil actuator, when energized by the electrical current that is generated by the first controller, reciprocally moves the drive member along a path of travel in the direction towards, and away from the conveying surface; a knife which is mounted on the drive member of the voice coil actuator, and which further has a distal cutting edge, and which is operable to engage, and sever, objects in the stream of discrete objects, and which have identified undesirable features as determined by the controller from analyzing the image signal delivered to the first controller from the first image capturing device, and wherein the first controller is effective, following an identification of an undesirable feature on an object, to energize the voice coil actuator so as to move the knife into, and out of, engagement with the object having an identified undesirable feature so as to severingly separate the identified, undesirable feature from the object which is moving within the object stream, and wherein the signals generated by the first and second sensors, and the admittance measuring device and which are transmitted to the controller are used by the controller to determine, at least in part, a cutting characteristic of the knife; a second image capturing device which is located elevationally, above, the conveying surface, and is further located in spaced relation, and downstream relative to, the first mentioned image capturing device, and wherein the second image capturing device generates an image signal which is representative of the discrete objects, undesirable foreign objects, and severed undesirable features which were derived from the discrete objects, after the discrete objects were previously engaged by the knife; a second illumination device which is located elevationally above the conveying surface, and adjacent the second image capturing device, and wherein the second illumination device, when energized, emits electromagnetic radiation which is reflected from the discrete objects, foreign objects, and the severed, undesirable features of the discrete objects, and which are passing below the second image capturing device, and wherein the reflected electromagnetic radiation is captured by the second image capturing device; a second controller which is coupled in controlling relation relative to each of the second image capturing device; second illumination device, and a defect and foreign object removal device which is located near the distal end of the conveying surface, and wherein the second controller identifies the discrete objects, foreign objects, and severed undesirable features which are derived from the discrete objects, and which are identified from the image signal supplied by the second image capturing device, and which is supplied to the second controller, and wherein the second controller generates a control signal which is transmitted to the defect and foreign object removal device, and which is subsequently effective in rendering the defect and foreign object removal device operable to remove the foreign objects, and severed undesirable features derived from the stream of discrete objects so as to produce a uniform stream of objects; and an operator interface which is operably coupled with each of the controllers, and wherein the cutting characteristics of the knife is transmitted by the first mentioned controller to the operator interface for display to an operator.

These and other aspects of the present invention will be described in greater detail hereinafter.

### BRIEF DESCRIPTION OF THE DRAWINGS

Preferred embodiments of the invention are described below with reference to the following accompanying drawings.

FIG. 1 shows a highly simplified view of a cutting apparatus of the present invention, and which is employed with a conveying surface for transporting a stream of objects for processing.

FIG. 2 is a fragmentary, side elevation view of a voice coil actuator, bearing a knife, and which finds usefulness as a feature of the present invention.

FIG. 3 is a first, diagrammatic representation of an electrical impedance of a voice coil actuator in operation. FIG. 3A is a diagrammatic representation of the electrical impedance of a voice coil actuator, over time, and during operation.

FIG. 4 is a second, diagrammatic representation of an electrical impedance of a voice coil actuator during the operation of the present invention. FIG. 4A is a diagrammatic representation of the electrical impedance of a voice coil actuator, over time, and during operation.

FIG. 5 is a fragmentary, perspective, side elevation view of a voice coil actuator, and which is a feature of the present invention.

FIG. 6 is a transverse, vertical, sectional view of a voice coil actuator which is a feature of the present invention, and which is further taken from a position along line 6-6 of FIG. 5.

FIG. 7 is a fragmentary, greatly simplified, side elevation view of a drive member which is employed in a voice coil actuator, and which further is a feature of the APPAL doc 7 present invention. FIG. 7 illustrates electrically conductive coils that are respectively positioned radially outwardly relative to a drive member, and wherein the respective coils each circumferentially extend in opposite directions about, and in spaced relation relative to, the drive member.

FIG. 8 is a fragmentary, greatly simplified view of a drive member which is made integral with a voice coil actuator, and which is a feature of the present invention. In FIG. 8 a pair of spaced, electrically conductive coils which are, respectively, positioned radially outwardly relative to the drive member.

FIG. 9 is a greatly simplified view of a distal end of a knife which forms a feature of the present invention, and which is moveable along a semi-circular, and at least partially and arcuately shaped path of travel.

FIG. 10 is a fragmentary, greatly simplified, side elevation view of a distal end of a knife, and which forms a feature of the present invention, and which is further rotatable about its longitudinal axis.

FIG. 11 is a greatly simplified, side elevation view of a distal end of a knife, and which forms a feature of the present invention, and which is further mechanically moveable along a semi-circular or elliptical path of travel to achieve the objects of the present invention.

FIGS. 12(a) and 12(b) are greatly simplified, side elevation views of a distal end of a knife, and which forms a feature of the present invention, and which, again, is moveable along a predetermined, semi-circular path of travel to achieve the objectives of the present invention.

FIG. 13 is a greatly simplified, side elevation view of a distal end of a knife which forms a feature of the present invention, and which is further moveable along a given path of travel by means of a selectively energizable electromagnetic assembly.

FIG. 14 is a side elevation view of yet another form of the present invention, and wherein the distal end of a knife, which forms a feature of the present invention, is moved along an arcuately shaped path of travel by an electromagnetically driven drive member.

FIG. 15 is a side elevation view of a voice coil actuator which forms a feature of the present invention, and wherein the knife forming a feature of this voice coil actuator is rotatable about its longitudinal axis.

FIGS. 15A and 15B are top plan views of elongated objects which have been selectively severed in various angular orientations by the present invention.

FIG. 16 is a longitudinal, vertical, sectional view, and which is taken from a position along line 16-16 of FIG. 15.

FIG. 17 is an end view of the voice coil actuator as seen in FIG. 16.

FIG. 18 is a longitudinal, vertical, sectional view of a voice coil actuator having an alternative arrangement from that seen in FIG. 16.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

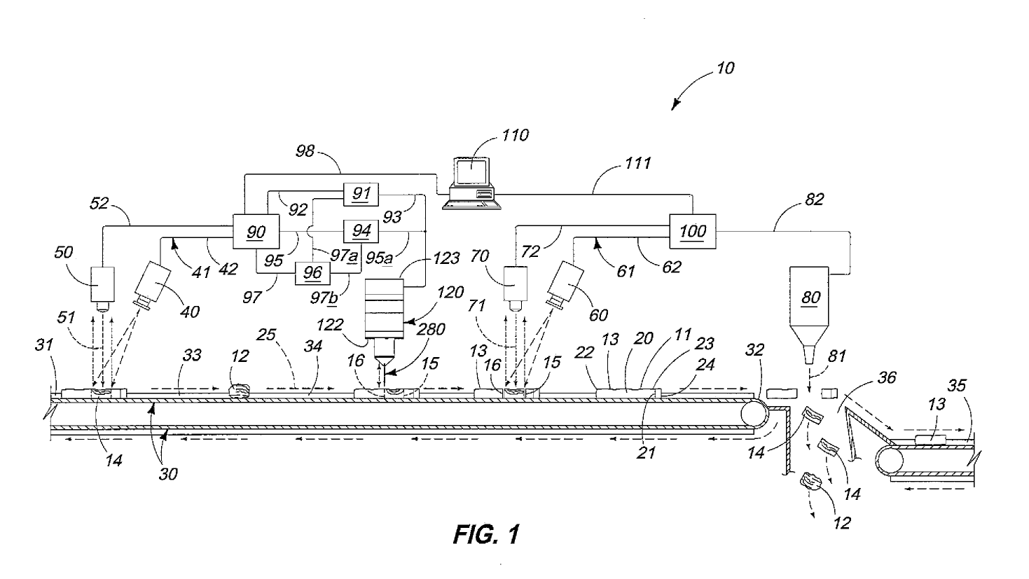

Referring now to the drawings, the cutting apparatus of the present invention is best understood, and is designated by the numeral 10, in FIG. 1 and following.

Referring now to FIG. 1, the cutting apparatus 10 of the present invention is operable to be used on a stream of discrete products, or objects, and which are indicated generally by the numeral 11. As depicted, the discrete objects 11 in the stream are shown as being narrowly elongated in shape as might typically be the case with food products such as French fries, green beans and the like. However, the present device could be used on a stream of objects having other shapes, Mixed into this stream of discrete objects 11 are foreign objects 12, and which is herein depicted as a rock. The stream of discrete objects includes acceptable objects 13; and acceptable objects having undesirable features, and which are labeled by the numeral 14. The undesirable features may include growth deformities; discolored regions; or areas of rot, for example, With regard to the objects having undesirable features 14, the undesirable feature has a beginning, and an end location 15 and 16, respectively. The acceptable objects 13 further have a main body 20 which has a first end 21, an opposite second end 22, and an exterior facing surface 23. A thickness dimension 24 is measured between the opposite exterior facing surfaces 23. The stream of discrete objects 11 is moved along a predetermined course of travel which is generally indicated by the numeral 25.

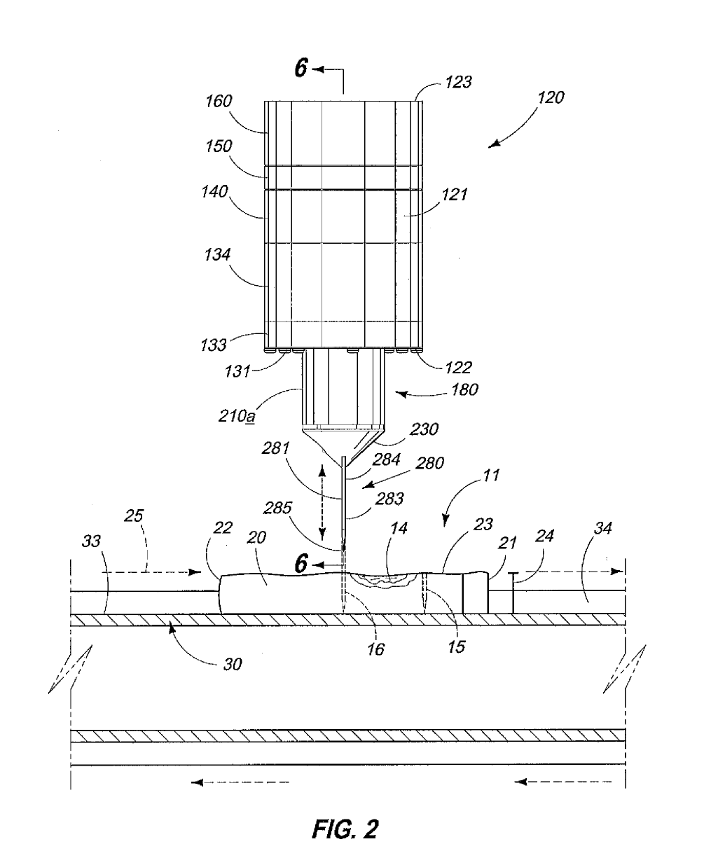

A conveying surface 30, here depicted as a continuous conveyor belt, is provided for transporting the stream of discrete objects 11 along the predetermined course of travel 25. The conveying surface 30 has a first, intake end 31, and a second or exhaust end 32. The conveying surface further has, at least in part, a planar upwardly facing surface 33 for supporting the individually discrete objects 11 on the conveying surface 30. In some forms of the invention, the upwardly facing surface has a predetermined number of predefined lanes 34 (FIG. 2) and which are individually defined by the upwardly extending surface 33, and which facilitates the orientation, or location of the individual discrete objects 11, forming the stream, into predetermined positions within the respective lanes. In one possible form of the invention, the planar upwardly facing surface 33 is uniformly planar across its width dimension, and therefore the stream of discrete objects 11 are oriented in random positions across the upwardly facing surface 33. Positioned in spaced relation relative to the second end 32 is a downstream take-away conveyor 35 (FIG. 1). The take-away conveyor 35, is only depicted in part, as a continuous conveyor belt. The take-away conveyor is located in spaced relationship relative to the conveying surface 30, and a gap 36 is defined between the second end 32 of the conveying surface 30, and the take-away conveyor 35. This gap allows for foreign objects 12, and undesirable features previously severed from acceptable objects 14, to pass therethrough, once these objects have been identified in the stream of discrete objects 11, as will be discussed in greater detail hereinafter.

The cutting assembly 10 of the present invention includes a first image capturing device which is generally indicated by the numeral 40 (FIG. 1). The first image capturing device is located elevationally, above, the elongated conveying surface 30, and which further periodically generates a first image signal 41, and which is representative of the discrete objects 11 which are being transported past the image capturing device 40 by the movement of the conveying surface 30. As seen, the image capturing device 40, when rendered operable, produces a first image signal 41 which is transmitted by way of the electrical conduit 42, to a controller, and which will be discussed in greater detail below. While an electrical conduit is shown, it will be appreciated that this signal could be transmitted wirelessly, if desired. The cutting apparatus 10 further includes a first illumination device which is generally indicated by the numeral 50, and which is further located elevationally, above, the conveying surface 30, and which, when energized, emits electromagnetic radiation 51 which is reflected from the discrete objects 11, and which are being transported past the image capturing device 40 by the movement of the conveying surface 30. The first illumination device 50 is electrically coupled to a controller, as will be discussed hereinafter, by means of an electrical conduit 52, as seen in FIG. 1. The controller, as will be described, below, is effective in selectively energizing the first illumination device, 50. The cutting apparatus 10 further includes a second image capturing device 60, and which is located elevationally above the conveying surface 30, and is further located in spaced relation, and downstream relative to, the first mentioned image capturing device 40. The second image capturing device periodically generates an image signal 61 which is representative of the discrete objects 11; undesirable foreign objects 12; and severed undesirable features 14 which are derived from the discrete objects 11 after the discrete objects 11 where previously engaged by a knife, as will be discussed in greater detail, below. An electrical conduit 62 transmits the second image signal 61 to a second controller which will be discussed in greater detail, below. Again this second image signal 61 could be transmitted wirelessly, if desired. The cutting apparatus 10 includes a second illumination device 70 which is located elevationally, above, the conveying surface 30, and adjacent to the second image capturing device 60. The second illumination device is electrically coupled to a controller (as will be discussed, below) by means of the electrical conduit 72. The second illumination device 70, when energized, emits electromagnetic radiation 71, and which is reflected from the discrete object 11, foreign objects 12, and the severed undesirable features 14 of the discrete objects 11, and which are passing below the second image capturing device 60. The reflected electromagnetic radiation 71 is captured by the second image capturing device 60.

A defect and foreign object removal device is generally indicated by the numeral 80, and is seen in FIG. 1. The defect and foreign object removal device 80 is positioned adjacent to the second or exhaust end 32 of the conveying surface 30. The defect and foreign object removal device 80 is well known, and typically comprises an air manifold of conventional design, and which is operable to supply a selectively actuatable pressurized air ejection 81 which forces previously identified foreign objects 12, and acceptable objects having undesirable features 14 from the stream of objects 11 so as to produce a uniform object stream which is then delivered to the downstream take-away conveyor 35. The defect and foreign object removal device 80 is coupled by means of an electrical conduit 82 to a second controller which will be discussed in greater detail below. The defect and object removal device is coupled to a supply of pressurized air, (not shown).

The cutting apparatus 10 includes a first controller which is generally indicated by the numeral 90. The first controller 90 is coupled in controlling and image signal receiving relation relative to the first image capturing device 40, and further is coupled in controlling relation relative to the elongated conveying surface 30, and first illumination device 50. The first controller 90 is further operable to visually identify individual objects moving along in the stream of discrete objects 11, and discriminate whether they are either foreign objects 12; or discrete objects having undesirable features 14 which must be cut so as to sever the undesirable feature 14 from the object. Once the undesirable feature is severed, it is subsequently removed from the stream of objects 11 so as to produce a uniform stream of objects, and which are delivered to the downstream take-away conveyor 35. The first controller 90 generates a control signal as will be described, below, and which identifies a location on an identified object 11 having an undesirable feature 14, This control signal indicates a location where the undesirable feature begins 15, and ends 16, or identifies the object as a foreign object 12. The control signal causes the first controller 90 to generate a predetermined electrical current or a control signal as described above. The cutting apparatus 90 further includes a first sensor 91 for measuring an amperage of the electrical current which is generated by the first controller 90 and which is supplied to a voice coil actuator as will be described, below. As should be understood, the first sensor 91 is coupled in signal transmitting relation relative to the first controller 90 by means of an electrical conduit 92 as illustrated. The cutting apparatus has an electrical conduit 93, and which extends between the first sensor 91, and which further terminates at a voice coil actuator as will be discussed in greater detail, below. Still further, the cutting apparatus 10 has a second sensor 94 for measuring the voltage of the electric current which is generated by the first controller 90. The second sensor 94 is coupled in signal transmitting relation relative to the first controller 90 by way of the electrical conduit 95. The electrical conduit 95 is electrically coupled to, and extends between the second sensor 94, and the controller 90. This relationship is best seen by FIG. 1. In addition to the foregoing, an electrical conduit 95(a) is provided, and which extends between the electrical conduit 93, and the second sensor 94. The cutting apparatus 10 further includes an admittance measuring device 96 which is electrically coupled with each of the first controller 90, the first sensor 91, and the second sensor 94, in a feedback loop arrangement, and which is further coupled in a single transmitting relationship relative to the first controller 90. This electrical coupling is achieved by the electrical conduit 97 as seen in FIG. 1. The electrical conduit 97 has a portion, 97(a) which is electrically coupled to, and extends between the first sensor 91 and the admittance measuring device 96. Further the electrical conduit 97 has a second portion 97(b) which extends between, and is electrically coupled to the second sensor 94, and the admittance measuring device 96. The controller is electrically coupled to an operator interface, as will be described, below, by an electrical conduit 98.

The cutting apparatus 10 includes a second controller 100 which is coupled in controlling relation relative to each of the second imaging capturing device 60; second illumination device 70, and a defect and foreign object removal device 80, and which is located near the distal end 32 of the conveying surface 30. The second controller 100 identifies the discrete objects 11; foreign objects 12; and severed undesirable features 14 which are derived from discrete objects 11; and which are identified from the image signal 61 which is supplied by the second image capturing device 60. The image signal 61 is further supplied to the second controller 100. The second controller 100 generates a control signal which is transmitted by way of the electrical conduit 82 to the defect and foreign object removal device 80, and which is subsequently effective in rendering the defect, and object removal device 80 operable to remove the foreign objects 12, and severed undesirable features 14, and which are derived from the stream of discrete objects 11, so as to produce a uniform stream of objects which is delivered to the take-away conveyor 35. An operator interface 110 is provided, and which is operably coupled with each of the controllers 90 and 100, respectively. The cutting characteristics of a knife, as will be discussed in greater detail, hereinafter, are transmitted by the first mentioned controller 90, to the operator interface 110, for display to an operator (not shown). The operator interface 110 is electrically coupled to the controller 100 by way of an electrical conduit 111. Again, this controlling connection could be made wirelessly.

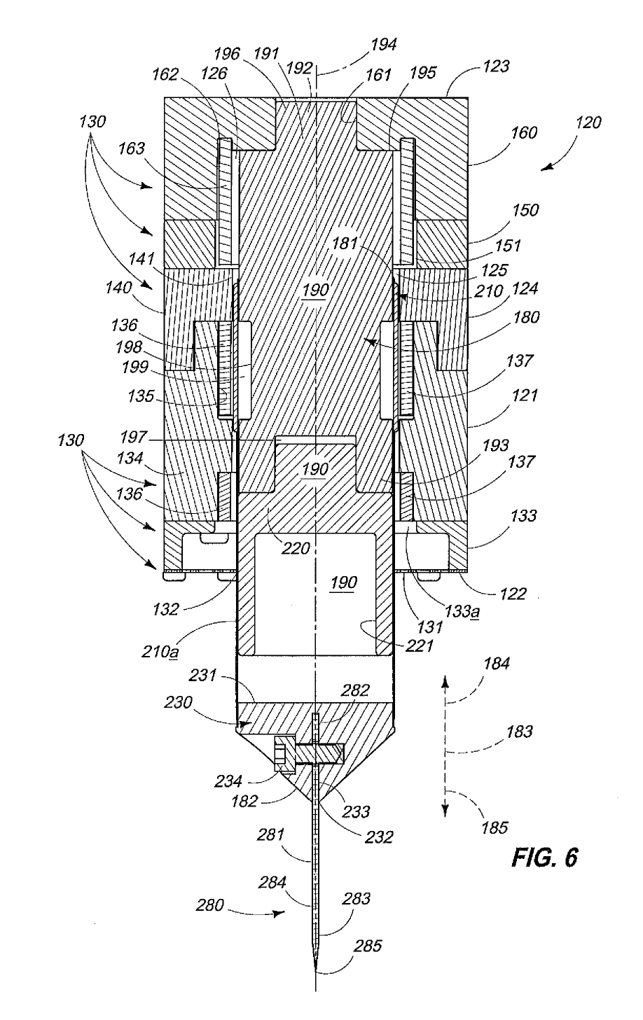

The cutting apparatus 10 of the present invention includes a voice coil actuator, and which is generally indicated by the numeral 120. The voice coil actuator 120 is electrically and controllably coupled with the first controller 90, and which is further positioned elevationally, above, the conveying surface 30. The voice coil actuator 120 receives the electrical current which is generated by the first controller 90. The voice coil actuator 120 further includes a moveable drive member as will be discussed, below, and which is effective for carrying a knife as will be also described, below, along a reciprocal path of travel in a direction towards, and then away from the conveying surface 30. With regards to the voice coil actuator 120, the voice coil actuator has a main body 121 which has a first end 122, and an opposite second and distal end 123. The main body has an exterior facing surface 124, (FIG. 6) and an opposite interior facing surface 125 which defines an internal cavity 126. The voice coil actuator 120, is mounted downstream relative to the first image capturing device 40, and above the conveying surface 30.

Referring now to FIG. 6, the voice coil actuator 120, and more specifically the main body 121 thereof, is manufactured from multiple portions, and which are generally indicated by the numeral 130. The main body 121 includes a suspension element or end plate 131, and which is located at the first end 122 of the main body 121. The suspension element or end plate 131 can be fabricated from various materials including metal, plastic, and natural materials of various types. The suspension element 131 is rigid, and further has an aperture 132 formed substantially centrally thereof. The aperture 132 has predetermined dimensions, and which allows a portion of a driving member to extend, and reciprocate therethrough. The suspension element 131 is mounted on, or is made integral with a suspension lifter, or spacing element, and which is generally indicated by the numeral 133. The suspension lifter or spacing element 133 is provided so as to maintain the suspension element or end plate 131 in spaced relation relative to the remainder of the main body 121. The spacing element further provides a mechanical clearance for the driving member, during its operation, as will be described in greater detail, below. Again, a passageway 133A is formed substantially centrally relative to the suspension lifter or spacing element 133. The passageway defined by the suspension lifter, or spacing element 133A, is coaxially aligned with the aperture 132. The suspension lifter, or spacing element 133, is juxtaposed relative to, and affixed, or mounted on a first gap plate, and which is generally indicated by the numeral 134. The gap plate 134 is fabricated in a fashion so as to create a first magnetic gap for an associated voice coil which will be discussed in greater detail below. The first gap plate has an interior facing surface 135, and which defines a pair of recessed, and spaced seats 136. Individual shorting rings 137 are respectively received within the pair of recessed seats 136. The respective shorting rings are fabricated from a non-magnetic, electrically conductive material such as copper, aluminum, brass and the like. The respective shorting rings 137 are used to reduce the inductance of a voice coil, during operation, and as will be discussed in greater detail, below.

The main body 121, of the voice coil actuator 120, includes a second gap plate 140, and which is positioned in juxtaposed relation relative to the first gap plate 134. The second gap plate 140 is employed to create a rear, or second, magnetic gap for the voice coil feature, and which will be discussed in greater detail, below. The second gap plate 140 defines an aperture 141, and which is substantially coaxially aligned with the apertures 132 and 133A, respectively. Additionally, the main body 121 includes a magnet 150 which is of substantially annular shape. The magnet 150 can be fabricated from ferrite, neodymium, alnico, cobalt samarium and other suitable materials. The magnet 150 defines a substantially centrally disposed aperture 151 which is coaxially aligned with the other apertures which have been previously described. The main body 120 includes a second end plate 160, and which lies in juxtaposed, and covering relation relative to the magnet 150. The second end plate defines a centrally disposed aperture 161. The second end plate 160 also defines a recessed region 162, and which is operable to receive, at least in part, a shorting ring 163, and which is similar in construction, and shape, when compared to the pair of individual shorting rings 137, and which were previously described. Again, the shorting ring may be manufactured from non-magnetic electrically conductive materials such as copper, aluminum, brass and the like. The shorting ring is used to reduce the inductance of the voice coil as will be described, below, during operation.

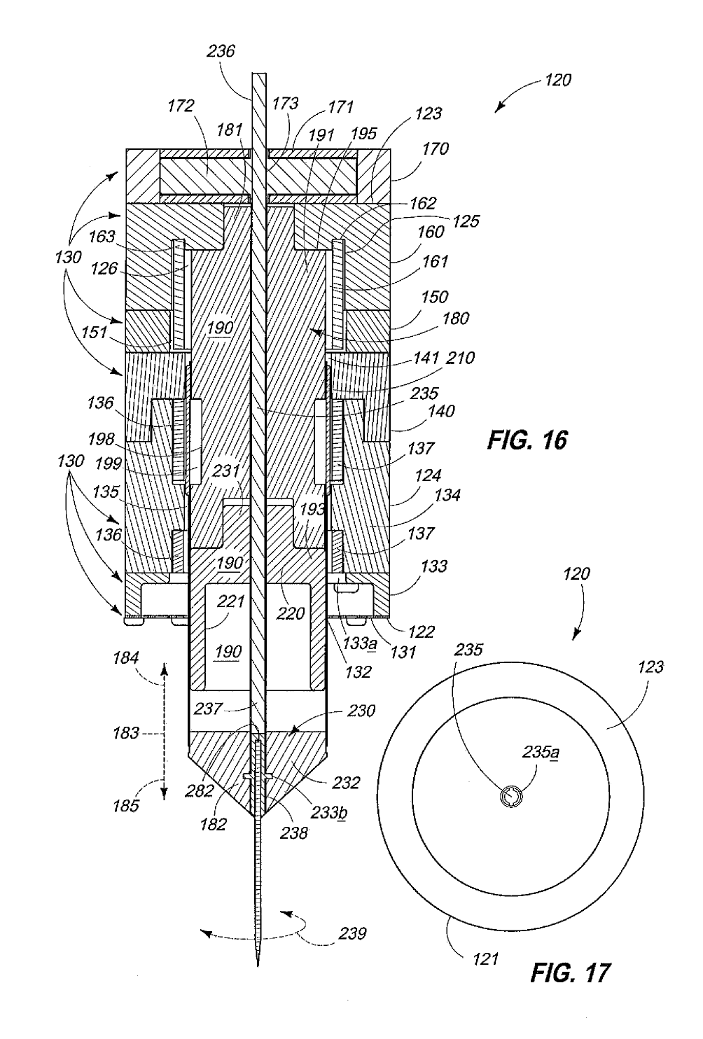

Referring now to FIG. 16, and in one possible form of the voice coil actuator 120, a support plate 170 is mounted outwardly relative to the second end 123 of the main body 121. The support plate 170 has formed therein a substantially centrally disposed cavity 171. A motor 172, of conventional design, and which is only generally indicated in the drawing, is positioned within the cavity 171. The motor 172 has a cylindrically shaped, and centrally disposed passageway 173, and which passes or extends therethrough, and which is operable to receive the drive shaft that will be discussed in greater detail, hereinafter. The multiple portions 130 are held or secured together using conventional fasteners and similar well known means.

As best seen in FIGS. 6 and 16, the voice coil actuator 120 includes a movable drive member, and which is generally indicated by the numeral 180. The drive member has a first end 181, and a second, distal end 182. The drive member 180 moves reciprocally along a path of travel which is generally indicated by the numeral 183 between a first retracted position 184, which is disposed in spaced relation relative to the conveying surface 30, to a second, extended, and object engaging position 185. In the second position 185, the distal or second end 182 carries a knife, as will be described below, into severing engagement relative to a selected object 11 which is passing therebelow the voice coil actuator 120.

Still referring to FIG. 6, the drive member 180 is formed or otherwise comprises multiple portions, and which are generally indicated by the numeral 190. The drive member has a center pole portion 191. The center pole 191 is fabricated from a material which provides a return path for a magnetic flux which extends from one surface of the magnet 150 to the opposite surface thereof. The magnet flux moves through the magnetic gaps as previously mentioned into the opposite surface of the magnet. This phenomena is well known in the art. The center pole 191 includes a first end 192, and an opposite second end 193. The drive member 190 is also defined, in part, by a longitudinal axis 194, and which extends substantially centrally through the center pole 191. As seen in FIG. 6, a recessed shoulder region 195 is formed in the first end 192. Still further, a longitudinally extending post 196 extends outwardly from the first end 192, and is sized so as to be received within the aperture 161. The recessed region 195 operates as a movement limiting feature which engages the second end plate 160, thus preventing further movement of the drive member 180 along the path of travel 183. A longitudinally oriented internal cavity 197 extends inwardly from the second end 193. Still further, a circumscribing channel 198 is formed in the center pole 191, and is located intermediate the opposite first and second ends 193. The circumscribing channel 198, defines a gap 199, and through which the magnetic flux travels, as earlier disclosed.

The drive member 180 further includes a voice coil which is generally indicated by the numeral 210, and which is positioned radially outwardly relative to the center pole 191. The voice coil comprises a set or series of circumscribing turns of an electrically conductive wire or conduit, and which is positioned on a form 210(a), and wherein when electricity is applied to the set or series of turns, the form 210(a) reciprocates within the internal cavity 126 of the main body 121. The action of the voice coil 210 is well known, and further discussion is therefore not warranted. Mounted on the second end 193 of the center pole 191 is a bearing member which is generally indicated by the numeral 220. The bearing member can be fabricated from any kind of synthetic low friction material and which is formed so as to couple with the second end 193. As will be seen, the bearing member 220 has a longitudinally extending internal channel 221, which is formed therein, and which is operable to matingly cooperate with a knife support member, and which is generally indicated by the numeral 230. Again, the knife support member 230 may be fabricated from any number of different materials including metals, plastics and the like. The knife support member has a first end 231, and an opposite distal second end 232. The first end 231 is positioned adjacent to the distal end of voice coil form 210(a). A knife receiving cavity 233 is formed in the distal, second end 232 of the knife support member, and a knife is received in same. The knife will be discussed in greater detail, hereinafter. A fastener, here shown as a threaded fastener 234, is operable to cooperate with the distal, second end 232 so as to secure the knife in releasable engagement with the distal second end 232. As should be understood, the knife support member 230 may be integrally fabricated so as to affix a distally extending knife thereto.

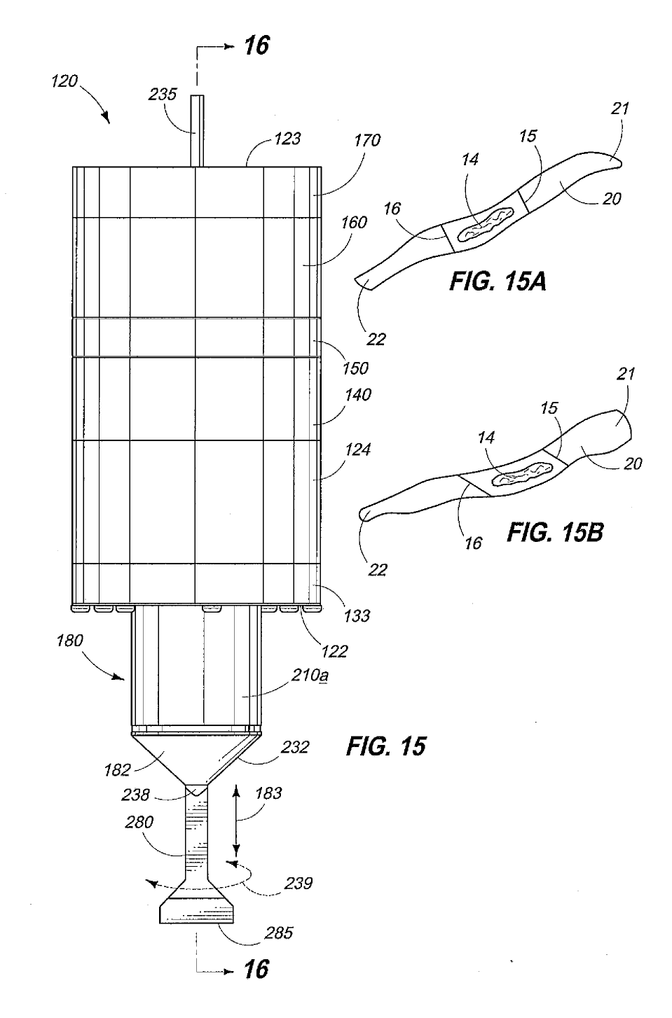

Referring now to FIG. 16, and in alternative form of the invention, the voice coil actuator 120 may include a drive shaft 235 which is received, and extends through, the main body 121 of the voice coil actuator 120. The drive shaft 235 is drivingly and forcibly engaged by the motor 172, and which is positioned within the cavity 171 of the support plate 170 as illustrated. The drive shaft has a first end 236 which is coupled in force receiving relation relative to the motor 172, and a second end 237 which is located within the knife support member 230. The first end 236 is located in the passageway 173 such that the motion of the drive shaft is longitudinally unrestricted, and rotational movement of the drive shaft 235 is constrained by the movement limiting features 235(a) which are mounted on the drive shaft 235, and which can be seen in FIG. 17. A structure 233(b) matingly cooperates with the second end 182, and is operable to constrain a knife receptacles longitudinal motion with respect to the knife support member 230. The structure, 233(b) rotates freely relative to the second end 182. The knife receptacle is discussed, below. The second end 237 mounts, and drivingly engages a knife receptacle 238, and which receives, and fixedly supports, a knife as will be described in greater detail, below. The motor 172, when selectively energized is operable to rotate the knife which is mounted on the knife support member 230 such that the knife, when engaging the respective objects 11 can make predetermined angular cuts of the objects as best seen, and appreciated by FIGS. 15A and 15B, respectively. The knife is rotatable about a rotational path of travel which is generally indicated by the numeral 239 in FIG. 16.

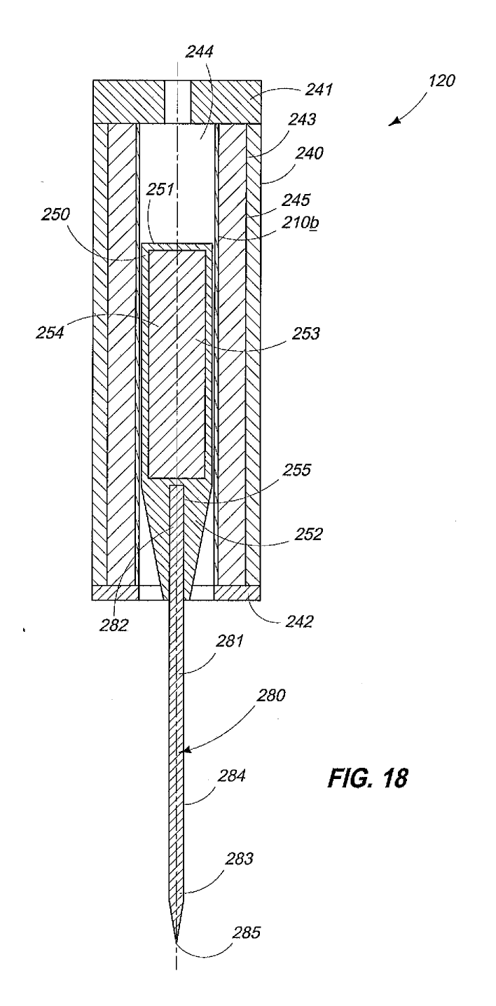

Referring now to FIG. 18, another form of the voice coil actuator 120 is illustrated. In this particular form of the invention, the voice coil actuator 120 has a housing which is generally indicated by the numeral 240. The housing has a first end 241, and an opposite second end 242. The housing further has an interior facing surface 243, and which defines an internal cavity 244 of predetermined dimensions. Positioned appropriately within the internal cavity 244 is a voice coil 245 as previously described, and which includes a plurality of conductive windings which are formed about a former 210(b), and which are located within the internal cavity 244. In this arrangement, the former 210(b) is immovably fixed in the housing 240. Mounted within the internal cavity 244 is a reciprocally movable drive member 250. The drive member has a first end 251 and an opposite second end 252. The drive member has an internal cavity 253, and into which a magnet 254, is positioned. The second end 252 has a knife receiving receptacle 255 which is formed therein, and which is further operable to receive a knife as will be described in greater detail below. Again, by applying electrical current to the voice coil 245, the magnet 254 is operable to propel the drive member 254, reciprocally, and within the internal cavity 244 of the housing 240, and to subsequently carry the knife, as will be described, below, in a reciprocal path of travel, and into engagement with selected objects traveling in the stream of objects 11, that are passing therebelow.

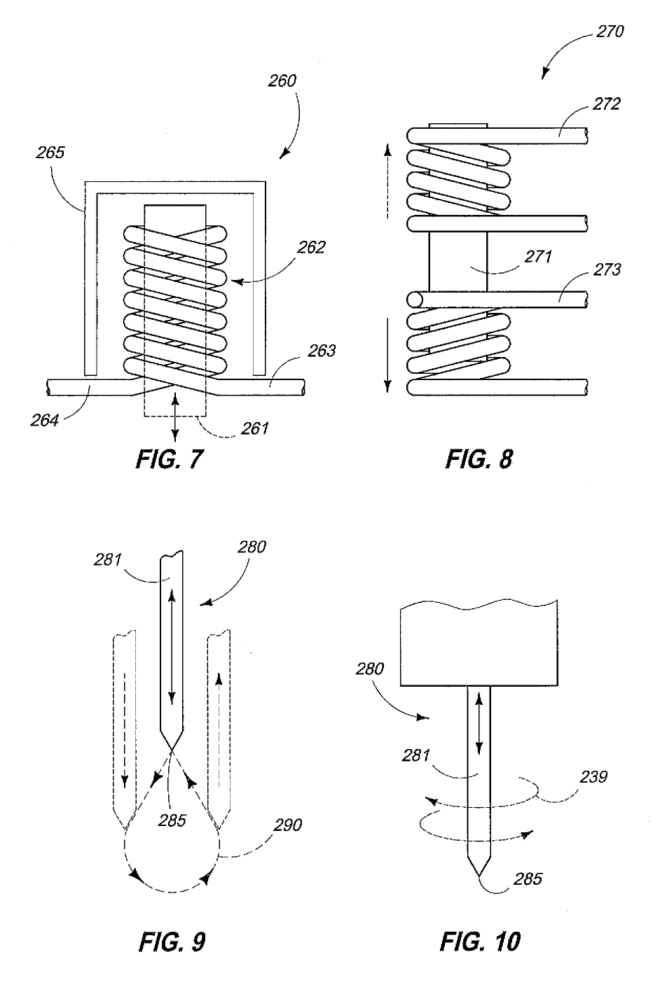

Referring now to FIG. 7, it should be understood that alternative arrangements for constructing a voice coil actuator 120 are possible. In particular, it will be understood that a first alternative voice coil actuator 260 is shown. In this very simplistic view, a drive member 261 is provided, and wherein a voice coil which is generally indicated by the numeral 262, and which includes a first conductive coil 263, and a second conductive coil 264, are respectively positioned radially, outwardly, relative to the drive member 261. As will be appreciated, the respective coils 263 and 264 each circumferentially extend in opposite directions about, and in spaced relation relative to the drive member 261. In this arrangement, and when the respective coils are energized, they have the effect of moving the drive member along a reciprocal path of travel and within the housing labeled 265. As will be appreciated, when one coil is energized, the other coil is not energized. In this arrangement, one coil draws the drive member 261 in one direction, and the second coil drives the drive member in the opposite direction, in a reciprocal manner.

Referring now to FIG. 8, a second, alternative form of the voice coil actuator 120 is generally indicated by the numeral 270. In this arrangement, the drive member is indicated by the numeral 271. The voice coil actuator 270 includes first and second electrically conductive coils 272 and 273, respectively, and which are each positioned radially outwardly relative to the drive member 271. In this arrangement, the respective electrically conductive coils are located in predetermined spaced relation, one relative to the other. Further, and when selectively energized, the respective coils are operable to urge or propel the drive member 271 either in one direction, or another, along a reciprocal path of travel.

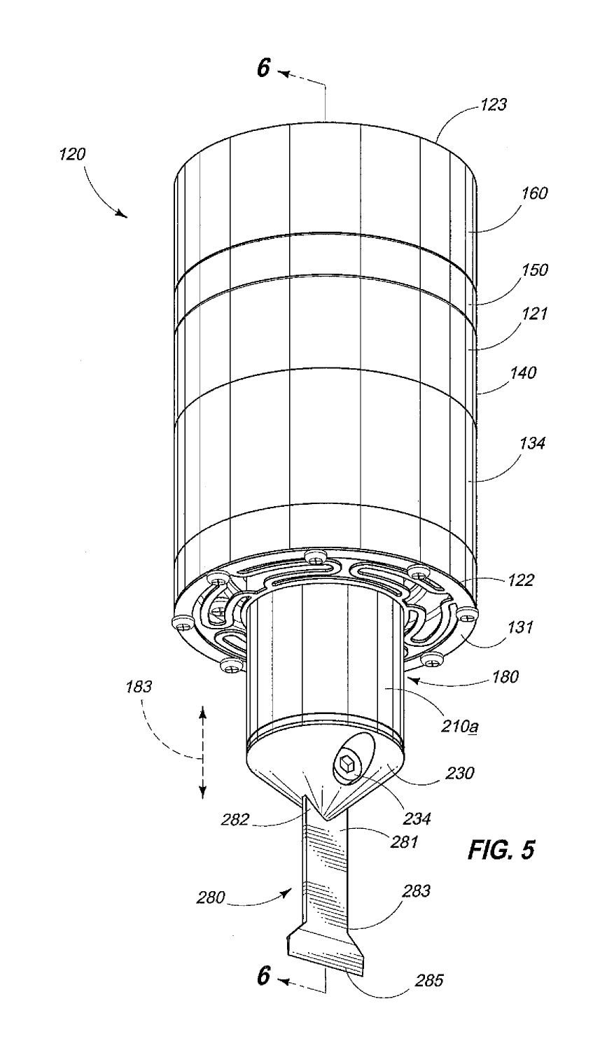

Referring now to FIGS. 2, 5 and 15, it will be seen that the voice coil actuator 120 mounts a reciprocally moveable knife, and which is generally indicated by the numeral 280, and which has been often referred to in the paragraphs, above. The knife 280, has an elongated main body 281, and which further has a first end 282 which is secured in, or made integral with the knife support member 230, and which is borne by or mounted on the drive member 180. As earlier discussed, the knife 280 may be made or fabricated in a manner where it is made integral with the drive member 180, or may be releasably mounted on the drive member 180 so that it may be easily removed for repair and replacement as necessary. The knife may be fabricated from various rigid materials including synthetic plastics, metal alloys which may or may not be magnetic, and combinations of both magnetic and non-magnetic materials. The knife 280 has a second, or distal end 283, and an elongated shaft 284 extends between the first and second ends and terminates at a cutting edge 285. The cutting edge is operable to engage selected objects 11 passing, therebelow, in order to sever undesirable features 14 from an object.

Referring now to FIG. 9, it will be seen that the knife 280 can be rendered operable so as to move along a path of travel 290 which is somewhat semi-circular. In this arrangement, the knife is moved in such a fashion such that the knife moves into contact with an object 11 therebelow, and then moves in the general direction that the object 11 is moving along the conveying surface 30. Therefore, the movement of the knife into severing engagement with the object 11 does not disturb the orientation of the object 11 on the conveying surface 30. Again, the knife 280 is reciprocally movable by means of the action of the voice coil actuator 120.

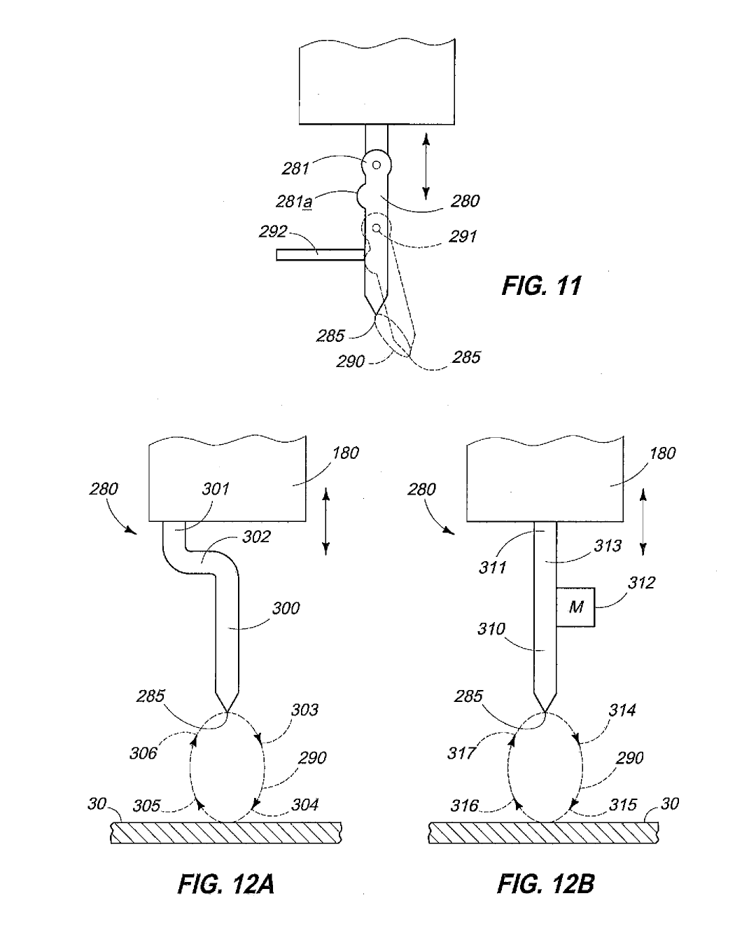

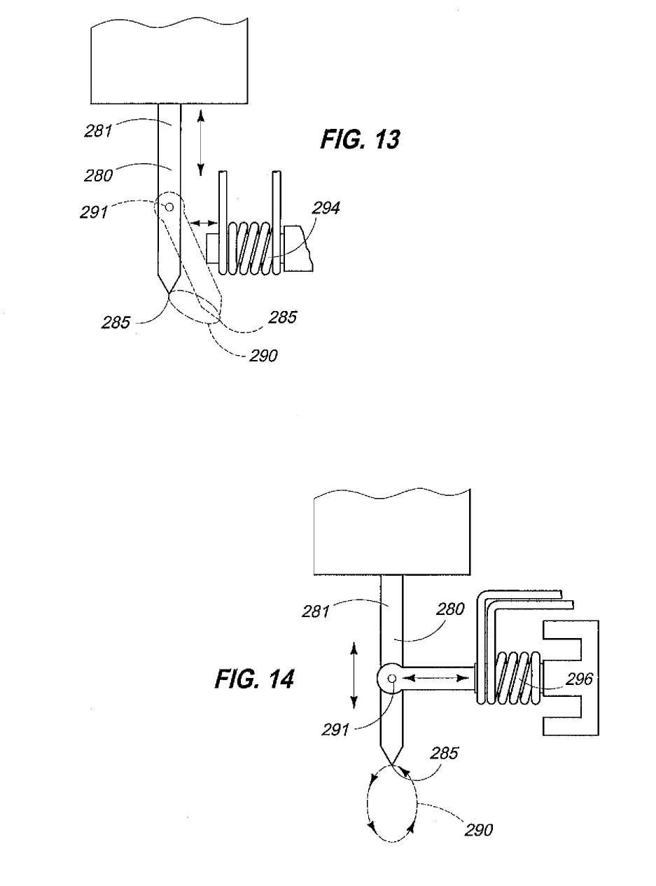

Referring now to FIG. 10, and as earlier discussed, the knife 280 can be rendered, in the form of the invention as seen in FIG. 16, rotatable about its longitudinal axis, and in a path of travel which is generally indicated by the numeral 234. This selective rotation of the knife 280 allows the cutting apparatus 10 to sever selected objects traveling therebelow the voice coil actuator 120 in various angular orientations as seen in FIGS. 15A and 15 B, respectively. As seen in FIG. 11, and in one form of the present invention 10, the knife 280 may be provided in a form, and where the main body 281, of the knife 280, is articulated or hinged as indicated by the numeral 291. As seen in FIG. 11, and in this form of the invention, the distal end of the knife having the cutting edge 285 may be urged by a fixed rigid member 292, riding against a protrusion 281(a) which is made integral with the knife, 280, out of substantially longitudinal orientation relative to the cutting apparatus 10 so as to allow the cutting edge 285 to travel in an arcuately, semi-circular or elliptically defined path of travel 290, thereby achieving a similar result as described, above. An alternative arrangement for this same, or quite similar movement of the distal end 285 of the knife 280 is seen in FIGS. 12A and 12 B respectively Referring now to FIG. 12A, the knife 280, as provided, has a main body 300 which has a proximal end 301, and which is positioned in an off-center relationship relative to the distal end 285. Further the main body has an intermediate region 302 which is somewhat resilient. As should be understood, as the drive member 180 moves the knife 280 downwardly toward the conveying surface 30, the acceleration affects a flexing of the knife about the intermediate region 302. Because of the off-set orientation of the knife 280, the edge 285 moves to the position labeled 303, which is along the path of travel 290. As the drive member moves toward the conveying surface 30, the controller 90 decelerates the knife 280, thereby causing the intermediate region 302 to flex, and move the distal end 285 downwardly. This movement is indicated by the number 304. As the distal edge 285 reaches the conveying surface 30, the controller 90, causes the drive member to draw the knife 280 upwardly, and in a direction away from the conveying surface. This acceleration away from the conveying surface 30 causes the knife edge 285 to move to the position labeled 305. As the drive member 180 moves the knife to the at rest position, which is in spaced relation relative to the conveying surface 30, the controller 90 causes the drive member to decelerate the knife 280. This deceleration causes the edge of the knife 285 to move to the positioned labeled 306. As will be appreciated, therefore, the knife edge 285 moves along a semi-circular or elliptical path of travel 290. With this arrangement, a product or object in a stream 11 can be cut or severed while moving past the knife 280, but the cutting is accomplished in a manner such that the knife edge 285 follows the movement of the product or object being severed. Therefore, the subsequent withdrawal of the knife 280 does not disturb the product or object 11 being severed, and which is moving along with the conveying surface 30. Referring now to FIG. 12B, still another and an alternative form of the knife 280 is shown, and wherein the knife 280 has a main body 310, with a first end 311, which is mounted in force receiving relation relative to the drive member 180. Further a mass 312, of a given weight, is attached, or made integral with, the knife 280, at a location which is intermediate to the first end 311, and the cutting edge 285. Again, and similar to that which was described, above, regarding the structure as seen in FIG. 12A, a region 313 is provided, and which allows the main body 311 to resiliently flex relative to same. Upon the movement of the knife 280 toward the conveying surface 30, the mass 312, upon acceleration of the knife, causes the main body 310 to flex at the region labeled 313, thus moving the knife edge 285 to the position labeled 314. Further, as the knife 280 is decelerated, and before reaching the conveying surface 30, the deceleration causes the knife edge 285 to move to the position 315. After the knife 280 severs the product or object in the stream 11, the acceleration of the knife away from the conveying surface 30 subsequently causes the knife edge 285 to move to the position which is labeled 316. Finally, as the knife 280 reaches its at rest position, and which is located in spaced relation relative to the conveying surface 30, the deceleration of the knife 280 causes the knife edge 285 to move to the position labeled 317. Again the edge of the knife 280 moves along the semi-circular or elliptical path of travel 290. Referring now to FIG. 13, it will be seen that the knife 280 can be fabricated from a material which is magnetically attractive, and wherein the cutting apparatus may further include an electromagnet which is generally indicated by the numeral 294, and which can exert a magnetic force which causes the distal end of the knife 280 to move laterally, outwardly, so as to allow the cutting edge 285 to engage an object having undesirable features 14 passing therebelow. Referring now to FIG. 14, yet another form of the invention 10 is shown, and wherein the knife 280 has attached thereto a drive member 295, and which is magnetically drawn to the side, or laterally outwardly, by an electromagnet 296 in order to move the cutting edge 285 into a position where it can engage objects having undesirable characteristics 14 passing, therebelow.

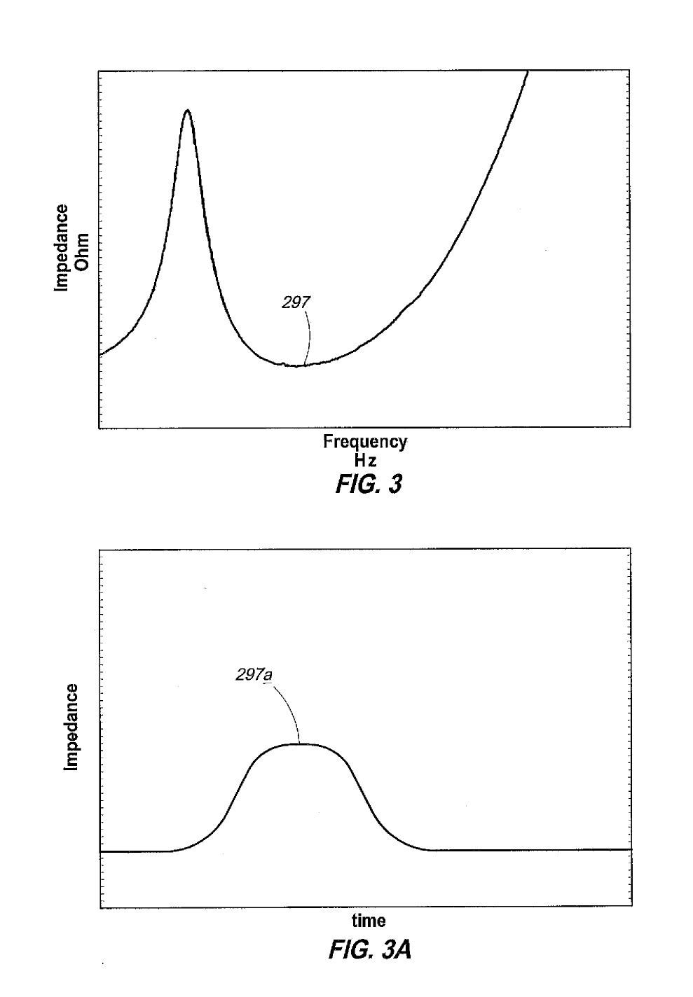

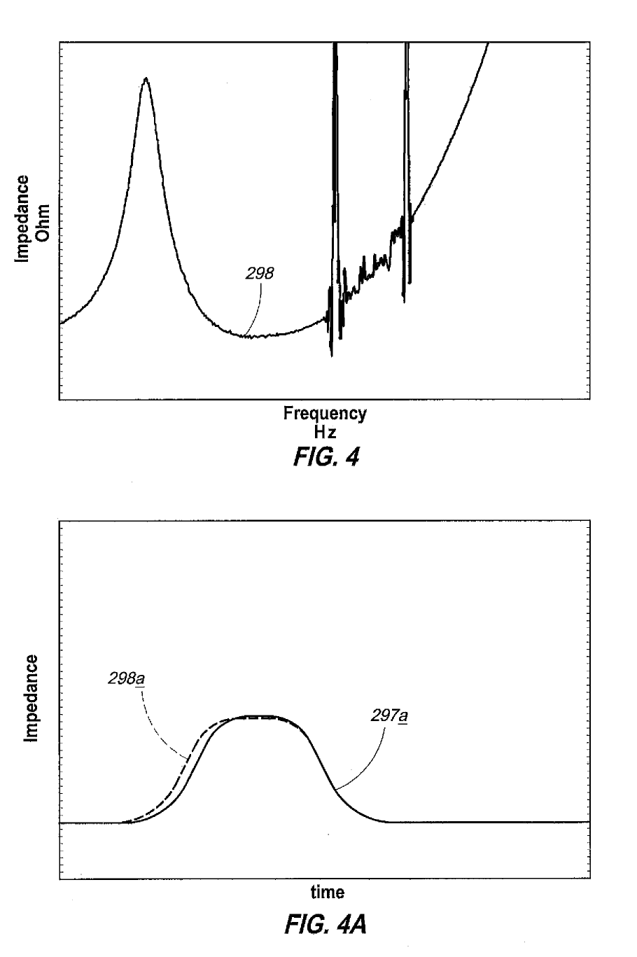

The cutting performance of the knife 280 can be determined by the electrical signals generated by the first and second sensors 91 and 94; and the admittance measuring device 96 as earlier disclosed. Referring now to FIGS. 3 and 3A, an impedance of the voice coil 210, in operation, and which is being propelled by the electromagnetic force generated by the voice coil actuator 120 over a range of operating frequencies, and over time is shown. The admittance device 96 is operable for measuring an admittance of the electrical current and which is supplied by the controller 90 to the voice coil actuator 120. As seen in FIGS. 3 and 3A, the impedance of the voice coil 210 at specific operating frequencies, and over time, and which are plotted in these views tend to illustrate an operational characterization specific to a particular voice coil actuator 120, and which is being activated. In this regard, and from analysis of this electrical utilization, a base line operational threshold for the cutting apparatus 10 can be determined. This curve as seen in FIG. 3 is labeled by the numeral 297. Referring now to FIGS. 4 and 4A, a second impedance curve 298 is illustrated, and wherein the impedance curve is interrupted. This illustrates a change in the overall cutting apparatus 10 system dynamics during a swept drive signal frequency. This is indicative of how the impedance could change as a function of the coil 210 motion which is caused by an external force or resistance encountered by the knife 280 during operation. During operation the time series variation in impedance may resemble the curve 297(a) as illustrated in FIG. 3A. During the actuation, if a sudden change in speed is caused by an outside force or other resistance encountered by the knife 280, the impedance would deviate from the expected curve as seen by the curve labeled 298(a). It will be recognized that the controller 90, upon receiving signals such as this may determine the knife cutting characteristics. As will be appreciated that as the cutting apparatus 10 is being employed, and by reviewing the impedance curves as seen in FIGS. 3(a) and 4(a) respectively, if abnormal operations are observed, then the knife 280 can be retracted, and identified for possible repair or replacement if it has impacted a foreign object 12 such as a stone or the like. Further, if the knife 280 has broken, it will have a different mass, and therefore the impedance curves 297, and 297(a) as measured by the controller 90 will be different. Again, in the aforementioned situation, the knife 280 can be identified, and then readily repaired, or replaced, as necessary. Additionally, by reviewing the impedance curve information, a slowed operation of the knife 280 as it passes through an object 11 can be detected by identifying increased electrical current utilized during the cutting operation. If increased electrical current is being employed by the voice coil actuator 120, the most likely scenario, or explanation is that the cutting edge 285 of the knife has become dulled, or on the other hand, the object or product being processed has changed to a degree that the amount of force necessary to sever the object 11 has changed. Such might occur, for example, when the thickness of the product has unexpectedly increased, or some products have been introduced, and which are, for example, partially frozen. During the operation of the cutting apparatus 10, a complex wave form will be utilized to implement cutting operations. For example, and referring to FIGS. 3 and 4, a high electrical current drive to overcome the momentum in the system, that is, to accelerate the knife 280, initially should be expected. Further, a constant current applied to provide even or constant velocity for the knife moving along the reciprocal path of travel would then be applied. As the knife 280 impacts, and begins cutting an underlying object, an increase in the amperage would be expected in order to sever the object 11. However, the amount of amperage applied would be just short of that necessary to drive the knife 280 to the conveying surface 30. Further, a reverse current would then be applied to slow the knife so as to barely make contact with the underlying conveying surface 30. A large reverse current would then be used to remove the knife 280 from the conveying surface 30, and from the underlying object 11. Again, a constant current would then be applied to return the knife to the at-rest position 184, and which is disposed in spaced relation relative to the conveying surface 30, Other variations of this complex wave form would be possible, of course. As earlier noted, the admittance measuring device 96 is coupled in a feedback loop arrangement with the first and second sensors 91 and 94. Those skilled in the art will recognize that admittance is a measure of how easily a circuited device will allow a current to flow. Its defined as the inverse of impedance. In combination, the first sensor 91, second sensor 94, and the admittance measuring device 96 provide a means whereby the controller 90 can determine the cutting performance of the knife 280, and which may be selected from the group including striking a foreign object; bending a knife 280; breaking a knife; striking a product or object having an increased or decreased thickness dimension; striking the underlying conveying surface 30; and/or the knife 280 has a distal cutting edge 285 which has become dull through usage and which needs replacement.

### Operation

The operation of the described embodiment of the present invention is believed to be readily apparent, and is briefly summarized at this point.

A cutting apparatus 10 for use on a stream of discrete objects 11 includes, as a first matter, a conveying surface 30 for transporting a stream of discrete objects 11 along a predetermined course of travel 25. Further, the cutting apparatus has an image capturing device 40, and which is located in spaced relation relative to the conveying surface 30, and which generates an image signal 41 which represents the individual discrete objects 11 as they are transported by the conveying surface 30. A controller 90 is coupled in image signal receiving relation relative to the image capturing device 40. The controller 90 is operable to identify objects 11, within the stream of discrete objects, and which have unacceptable features 14, and which further must be removed from the stream of discrete objects 11. The controller 90 generates a control signal which identifies a location 15/16 of an object 11 on the conveying surface 30, and which has an unacceptable feature 14. The cutting apparatus 10 includes a voice coil actuator 120, and which is coupled in control signal receiving relation relative to the controller 90, and which is located in spaced relation relative to the conveying surface 30. The voice coil actuator 120 is selectively, and electrically energized by the controller 90. Still further, the voice coil actuator 120 further includes a drive member 180 which moves, reciprocally, relative to the voice coil actuator 120, and in a direction both towards, and away from the conveying surface 30. The cutting apparatus 10 further includes a knife 280 which is mounted on the drive member 180 of the voice coil actuator 120. The control signal transmitted by the controller 90 is effective in selectively, and electrically energizing the voice coil actuator 120 so as to reciprocally move the knife 280, into and out of, engagement with the selected object 11 having unacceptable features 14 at a location where the unacceptable feature begins 15, and ends 16, so as to effectively sever the unacceptable feature from the object 11.

In the arrangement as seen in the drawings, a first illumination device 50 is provided, and which, when energized, emits electromagnetic radiation 51 which is directed towards, and reflected from, the stream of objects 11 being transported by the conveying surface 30. As should be understood, and depending upon the form of the invention, the illumination device 50 may emit visible electromagnetic radiation, or invisible electromagnetic radiation, or combinations of both. In the arrangement as earlier discussed, the controller 90 is operable to determine the cutting performance of the knife 280. The controller 90 is also operable to determine the depth of a cut made in the individually discrete objects 11 which are being transported by the conveying surface 30. As earlier discussed, the voice coil actuator 120 further includes a drive member 180. In one form of the invention, the drive member 180 is operable to reciprocally move along a path of travel 183 such that the knife 280 moves longitudinally outwardly relative to the voice coil actuator 120. In another form of the invention, the knife 280 may be rendered operable for rotation about its longitudinal axis, or further the distal end bearing the cutting edge 285 may be moved laterally sideways or outwardly so as to make angled cuts or for that matter, engage objects 11 which are placed in a random orientation on the conveying surface 30. As seen in FIG. 1, the cutting apparatus 10 includes a second image capturing device 60, and a second illumination device 70. Additionally, a second controller 100 is provided, and which is electrically, and controllably coupled to the second image capturing device; second illumination device, and the defect and foreign object removal device 80 which is positioned downstream relative to the distal end 32 of the conveying surface 30. As will be appreciated, foreign objects 12, and severed, unacceptable features of acceptable objects 14 may then be identified by the second controller 100, and a suitable control signal may be subsequently sent to the defect and foreign object removal device 80 so as to effectively remove or deflect the foreign objects and undesirable features 14 from the product stream, in order to produce a uniform or homogeneous stream of objects having no defects and a higher level of quality.

In the current arrangement, as seen in the drawings, the cutting apparatus 10 provides a means whereby the drive member 180 reciprocates along a path of travel 183, and which is typically less than about 25 millimeters. Further, the voice coil actuator 120 typically delivers a force of less than about 44,000 Newtons to the knife 280, and which can, in one form of the invention, be rendered releasably attachable to the drive member 180. In the arrangement as seen in the drawings, the voice coil actuator 120 propels the knife 280 at a speed of less than about 7.62 meters per second. Further, and in the arrangement as seen in the drawings, the conveying surface 30 is typically rendered operable to transport a stream of discrete objects 11 at a speed of about 1.0 to about 3.0 meters per second. Additionally, and as seen in the drawings, the first sensor 91 measures the amperage of the electrical current which is supplied by the controller 90, and provides a signal to the controller 90, and which indicates a cutting characteristic of the knife 280 which includes a power consumption of the voice coil actuator 120. Further, as seen in the drawings, the second sensor 94 measures the voltage of the electrical current, and which is supplied by the controller 90, and provides a signal back to the controller which indicates a cutting performance of the knife 280 which includes an electrical power usage of the voice coil actuator 120. In the arrangement as seen in the drawings, the admittance measuring device 96 provides a signal which indicates a cutting performance characteristic of the knife 280 which includes a force generated by the voice coil actuator 120, and which is directed to the object 11 being transported by the conveying surface 30. The characteristics of the operation of the knife 280 as well as information from the controllers 90, and 100 relative to the identification, and removal of foreign objects 12, and previously severed undesirable features 14 from acceptable objects 11 are transmitted to an operator interface 110 where an operator (not shown) may view the information, and make adjustments in the operation of the cutting apparatus 10, as appropriate.

Therefore, it will be seen that the present invention 10 provides a convenient means for cutting a stream of bulk products in an advantageous and highly desirable manner, and with an accuracy, and precision not possible with devices which have been utilized and employed, heretofore. The present invention is convenient, easy to operate, and service, and further provides multiple streams of information to an operator so that operational adjustments to the cutting apparatus may be readily made, and a resulting, high quality, bulk product can be produced.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. A cutting apparatus for use on a stream of discrete objects, comprising;
a conveying surface for transporting a stream of discrete objects along a predetermined course of travel;
an image capturing device located in spaced relation relative to the conveying surface, and which generates an image signal which represents the individual discreet objects as they are transported by the conveying surface;
a controller coupled in image signal receiving relation relative to the image capturing device, and wherein the controller is operable to identify objects within the stream of discrete objects, and which have unacceptable features, and which further must be removed from the stream of discrete objects, and wherein the controller generates a control signal which identifies a location of an object on the conveying surface which has an unacceptable feature;
a voice coil actuator coupled in control signal receiving relation relative to the controller, and which is located in spaced relation relative to the conveying surface, and wherein the voice coil actuator is selectively electrically energized by the controller, and wherein the voice coil actuator further includes a drive member which moves reciprocally relative to the voice coil actuator, and in a direction both towards, and away from the conveying surface; and
a knife mounted on the drive member of the voice coil actuator, and wherein the control signal transmitted by the controller is effective in selectively electrically energizing the voice coil actuator so as to reciprocally move the knife into and out of engagement with the object having unacceptable features at a location where the unacceptable feature begins, and ends, so as to effectively sever the unacceptable feature from the object.

2. A cutting apparatus as claimed in claim 1, and further comprising:
an illumination device which is positioned in spaced relation relative to the conveying surface, and which is further operably coupled with the controller, and wherein the illumination device, when energized, emits electromagnetic radiation which is directed towards, and reflected from, the stream of objects being transported by the conveying surface.

3. A cutting apparatus as claimed in claim 2, and wherein the illumination device emits visible electromagnetic radiation.

4. A cutting apparatus as claimed in claim 2, and wherein the illumination device emits invisible electromagnetic radiation.

5. A cutting apparatus as claimed in claim 1, and wherein the conveying surface defines a plurality of individual lanes which receive and orient the discrete objects in predetermined orientations relative to the conveying surface.

6. A cutting apparatus as claimed in claim 1, and wherein the conveying surface is substantially planar, and the discrete objects are oriented in random orientations relative to the conveying surface.

7. A cutting apparatus as claimed in claim 1, and further comprising:
a first sensor for measuring an amperage of an electrical current, and which is supplied by the controller to the voice coil actuator, and wherein the first sensor for measuring the amperage is electrically coupled with both the controller, and the voice coil actuator, and wherein the first sensor generates a first signal which is provided to the controller, and further, which indicates a cutting performance characteristic of the knife, and which is moved by the voice coil actuator into cutting engagement with the object on the conveying surface, and which has the unacceptable feature.

8. A cutting apparatus as claimed in claim 7, and further comprising:
a second sensor for measuring a voltage of the electrical current, and which is supplied by the controller, and wherein the second sensor is electrically coupled with each of the controller; first sensor; and the voice coil actuator, and wherein the second sensor generates a second signal which is provided to the controller, and which indicates a cutting performance characteristic of the knife, and which is moved by the voice coil actuator into cutting engagement with the object on the conveying surface, and which has the unacceptable feature.

9. A cutting apparatus as claimed in claim 1, and wherein the voice coil actuator has a single electrically conductive coil which is positioned radially outwardly relative to the drive member.

10. A cutting apparatus as claimed in claim 1, and wherein the voice coil actuator has a pair of electrically conductive coils, and which are respectively positioned radially outwardly relative to the drive member, and wherein the respective electrically conductive coils are located in predetermined, spaced relation, one relative to the other.

11. A cutting apparatus as claimed in claim 1, and wherein the voice coil actuator has a pair of electrically conductive coils, and which are respectively positioned, radially outwardly relative to the drive member, and wherein the respective coils each circumferentially extend in opposite directions about, and in spaced relation relative to the drive member.

12. A cutting apparatus as claimed in claim 8, and further comprising:
an admittance measuring device which is electrically coupled with each of the first sensor for measuring the amperage of the electrical current, and which is supplied by the controller, and the second sensor for measuring the voltage of the electrical current, and which is also supplied by the controller; and wherein the admittance measuring device provides a third signal to the controller and which indicates a cutting performance characteristic of the knife, and which is moved by the voice coil actuator into cutting engagement with the object having the unacceptable feature.

13. A cutting apparatus as claimed in claim 1, and wherein the controller is operable to determine the depth of a cut made in the individually discrete objects which are being transported by the conveying surface.

14. A cutting apparatus as claimed in claim 1, and wherein the driver which is movably borne by the voice coil actuator has a longitudinal axis, and wherein the voice coil actuator selectively rotates the knife about the longitudinal axis of the driver so as to effect a predetermined angular separation of the individually discrete objects which are being transported by the conveying surface.

15. A cutting apparatus as claimed in claim 1, and wherein the knife which is mounted on the driver has a distal end which is selectively moveable along an arcuately shaped path of travel while the knife is moving into and out of engagement with the object having the unacceptable feature, and which is being transported by the conveying surface.

16. A cutting apparatus as claimed in claim 15, and wherein the distal end of the knife is mechanically propelled along the arcuately shaped path of travel.

17. A cutting apparatus as claimed in claim 15, and wherein the distal end of the knife is fabricated, at least in part, from a material which is magnetically attractive, and wherein the distal end of the knife is selectively moved along the arcuately shaped path of travel by a selectively energizable magnet which emits a magnetic force which acts upon the distal end of the knife so as to propel the distal end of the knife along the arcuately shaped path of travel while the drive member is moving the knife into and out of engagement with the object having the unacceptable feature, and which is being transported by the conveying surface.

18. A cutting apparatus as claimed in claim 1, and wherein the controller is effective in identifying from the image signal which is generated by the image capturing device, undesirable foreign objects which are admixed with the stream of discrete objects, and wherein the cutting apparatus further comprises a defect and foreign object removal device which is positioned downstream of the conveying surface, and which is effective in removing the foreign objects, and severed unacceptable features, from the stream of discrete objects being transported by the conveying surface so as to produce a resulting homogenous stream of discrete objects.

19. A cutting apparatus as claimed in claim 18, and further comprising:
a second image capturing device which is located elevationally, above the conveying surface, and is further located in spaced relation, and downstream relative to, the first mentioned image capturing device, and wherein the second image capturing device periodically generates an image signal which is representative of the discrete objects, undesirable foreign objects, and severed unacceptable features which were derived from the discrete objects, after the discrete objects were engaged by the knife;
a second illumination device which is located elevationally above the conveying surface, and adjacent to the second, image capturing device, and wherein the second illumination device, when energized, emits electromagnetic radiation which is reflected from the discrete objects, undesirable foreign objects, and the severed unacceptable features of the discrete objects, and which are passing below the second image capturing device, and wherein the reflected electromagnetic radiation is captured by the second image capturing device;
a second controller which is coupled in controlling relation relative to each of the second image capturing device; second illumination device, and the defect and foreign object removal device which is located near the distal end of the conveying surface, and wherein the second controller identifies the discrete objects, undesirable foreign objects, and severed unacceptable features derived from the discrete objects, from the image signal supplied by the second image capturing device, and further generates a control signal which is sent to the defect and foreign object removal device, and which is effective in rendering the defect and foreign object removal device operable to remove the undesirable foreign objects, and severed unacceptable features which are derived from the stream of discrete objects; and
an operator interface which is operably coupled with each of the controllers, and wherein the cutting characteristics of the knife is transmitted by the first mentioned controller to the operator interface for display to an operator.

20. A cutting apparatus as claimed in claim 1, and wherein the voice coil actuator has a housing which encloses an immovable magnet which is located radially, outwardly, relative to the reciprocally moveable drive member.

21. A cutting apparatus as claimed in claim 1, and wherein the voice coil actuator has a housing which encloses a selectively moveable magnet which is located radially inwardly relative to the reciprocally moveable drive member.

22. A cutting apparatus as claimed in claim 1, and wherein the drive member reciprocates along a path of travel which is less than about 25 millimeters.

23. A cutting apparatus as claimed in claim 1, and wherein the voice coil actuator delivers a force of less than about 44,000 Newtons to the knife, and which is releasably mounted on the drive member.

24. A cutting apparatus as claimed in claim 1, and wherein the voice coil actuator propels the knife at a speed of less than about 7.62 meters per second.

25. A cutting apparatus as claimed in claim 1, and wherein the conveying surface transports the stream of discrete objects at a speed of about 1.0 to about 3.0 meters per second.

26. A cutting apparatus as claimed in claim 7, and wherein the first sensor which measures the amperage of the electrical current which is supplied by the controller, provides a signal to the controller and which indicates a cutting characteristic of the knife which includes a power consumption of the voice coil actuator.

27. A cutting apparatus as claimed in claim 8, and wherein the second sensor which measures the voltage of the electrical current, and which is supplied by the controller, provides a signal back to the controller which indicates a cutting performance of the knife which includes an electrical power usage of the voice coil actuator.

28. A cutting apparatus as claimed in claim 12, and wherein the admittance measuring device provides a signal which indicates a cutting performance characteristic of the knife which includes a force generated by the voice coil actuator and which is directed to the object being transported by the conveying surface.

29. A cutting apparatus as claimed in claim 19, and further comprising:
an operator interface which is coupled in signal receiving relation relative to the first mentioned controller, and wherein the cutting performance characteristic of the knife is provided to an operator by way of the operator interface.

30. A cutting apparatus as claimed in claim 1, and wherein the knife is releasably mounted on the drive member.

31. A cutting apparatus, comprising:
an elongated conveying surface having a longitudinal axis, and which transports a stream of discrete objects, and wherein the conveying surface has a first, intake end, and a second, exhaust end, and further conveys the stream of discrete objects at a given speed between the first and second ends thereof;
a first image capturing device located elevationally, above, the elongated conveying surface, and which further generates an image signal which is representative of the discrete objects which are being transported past the image capturing device by the movement of the conveying surface;
a first illumination device located elevationally, above, the conveying surface, and which, when energized, emits electromagnetic radiation which is reflected from the discrete objects which are passing below the first image capturing device, and which further is captured by the first image capturing device;
a defect and foreign object removal device which is positioned adjacent to the second, exhaust end of the conveying surface;
a first controller which is coupled in controlling, and image signal receiving relation relative to, the first image capturing device, and further is coupled in controlling relation relative to the elongated conveying surface, and first illumination device, and wherein the first controller is further operable to identify individual objects moving along in the stream of discrete objects, and which are either foreign objects, or discrete objects having an undesirable feature which must be removed from the stream of objects so as to produce a uniform stream of objects, and wherein the first controller generates a control signal which identifies a location on an identified object having an undesirable feature, and where the undesirable feature begins, and ends, or identifies the object as a foreign object, and wherein the control signal causes the first controller to generate a predetermined electrical current or a control signal;
a first sensor for measuring an amperage of the electrical current which is generated by the first controller, and wherein the first sensor is coupled in signal transmitting relation relative to the first controller;
a second sensor for measuring the voltage of the electrical current which is generated by the first controller, and wherein the second sensor is coupled in signal transmitting relation relative to the first controller;
an admittance measuring device which is electrically coupled with each of the first controller, and the second sensor, in a feed-back loop, and which is further coupled in signal transmitting relation relative to the first controller;
a voice coil actuator which is electrically, and controllably coupled with the first controller, and which is further positioned elevationally, above, the conveying surface, and wherein the voice coil actuator receives the electrical current which is generated by the first controller, and wherein the voice coil actuator further includes a moveable drive member having a distal end, and wherein the voice coil actuator, when energized by the electrical current that is generated by the first controller, reciprocally moves the drive member along a path of travel in the direction towards, and away from the conveying surface;
a knife which is mounted on the drive member of the voice coil actuator, and which further has a distal cutting edge, and which is operable to engage, and sever, objects in the stream of discrete objects, and which have an identified undesirable feature as determined by the controller from analyzing the image signal delivered to the first controller from the first image capturing device, and wherein the first controller is effective, following an identification of an undesirable feature in an object, to energize the voice coil actuator so as to move the knife into, and out of, engagement with the object having an identified undesirable feature, so as to severingly separate the identified, undesirable feature from the object which is moving within the object stream, and wherein the signals generated by the first and second sensors, and the admittance measuring device, and which are transmitted to the controller are used by the controller to determine, at least in part, a cutting characteristic of the knife;
a second image capturing device which is located elevationally, above, the conveying surface, and is further located in spaced relation, and downstream relative to, the first mentioned image capturing device, and wherein the second image capturing device periodically generates an image signal which is representative of the discrete objects, undesirable foreign objects, and severed undesirable features which were derived from the discrete objects, after the discrete objects were previously engaged by the knife;
a second illumination device which is located elevationally above the conveying surface, and adjacent the second image capturing device, and wherein the second illumination device, when energized, emits electromagnetic radiation which is reflected from the discrete objects, foreign objects, and the severed, undesirable features of the discrete objects, and which are passing below the second image capturing device, and wherein the reflected electromagnetic radiation is captured by the second image capturing device;
a second controller which is coupled in controlling relation relative to each of the second image capturing device; second illumination device; and the defect and foreign object removal device which is located near the distal end of the conveying surface, and wherein the second controller identifies the discrete objects, foreign objects, and severed undesirable features which are derived from the discrete objects, and which are identified from the image signal supplied by the second image capturing device, and which is supplied to the second controller, and wherein the second controller generates a control signal which is transmitted to the defect and foreign object removal device, and which is subsequently effective in rendering the defect and foreign object removal device operable to remove the foreign objects, and severed undesirable features derived from the stream of discrete objects so as to produce a uniform stream of objects; and
an operator interface which is operably coupled with each of the controllers, and wherein the cutting characteristics of the knife is transmitted by the first mentioned controller to the operator interface for display to an operator.

32. A cutting apparatus as claimed in claim 31, and wherein the cutting characteristic of the knife includes an amount of force exerted by the knife upon one of the discrete objects in the product stream, and wherein the force exerted by the knife on the discrete objects is correlated by the first controller with a multiplicity of known knife performance characteristics which are selected from the group comprising, striking a foreign object; bending a knife; breaking a knife; striking a product having an increased or decreased thickness dimension; striking the underlying conveying surface; and/or the knife has a distal cutting edge which has become dulled through usage and which needs replacement.

33. A cutting apparatus as claimed in claim 31, and wherein the conveying surface defines a plurality of individual lanes which receive and orient the discrete objects in predetermined orientations relative to the conveying surface.

34. A cutting apparatus as claimed in claim 31, and wherein the conveying surface is substantially planar, and the discrete objects are located in random orientations relative to the conveying surface.

35. A cutting apparatus as claimed in claim 31, and wherein the driver which is movably borne by the voice coil actuator has a longitudinal axis, and wherein the voice coil actuator selectively rotates the knife about the longitudinal axis so as to effect a predetermined angular separation of the individually discrete objects which are being transported by the conveying surface.

36. A cutting apparatus as claimed in claim 31, and wherein the knife which is mounted on the driver has a distal end which is selectively moveable along an arcuately shaped path of travel while the knife is reciprocally moving into and out of engagement with the object having the unacceptable feature, and which is being transported by the conveying surface.

37. A cutting apparatus as claimed in claim 36, and wherein the distal end of the knife is mechanically propelled along the arcuately shaped path of travel.

38. A cutting apparatus as claimed in claim 36, and wherein the distal end of the knife is fabricated, at least in part, from a material which is magnetically attractive, and wherein the distal end of the knife is selectively moved along the arcuately shaped path of travel by a selectively energizable magnet which emits a magnetic force which acts upon the distal end of the knife so as to propel the distal end of the knife along the arcuately shaped path of travel while the drive member is moving the knife into and out of engagement with the object having the unacceptable feature, and which is being transported by the conveying surface.
